(19) United States
(12) Patent Application Publication
(10) Pub. No.: US 2023/0401280 A1
(43) Pub. Date: Dec. 14, 2023

(54) DISTRIBUTED-COMPUTING METHOD FOR COMPUTING A METRIC REPRESENTATIVE OF A DIFFERENCE BETWEEN TWO DATA

(71) Applicant: IDEMIA IDENTITY & SECURITY FRANCE, Courbevoie (FR)

(72) Inventors: Hervé CHABANNE, Courbevoie (FR); Vincent DESPIEGEL, Courbevoie (FR)

(73) Assignee: IDEMIA IDENTITY & SECURITY FRANCE, Courbevoie (FR)

(21) Appl. No.: 18/334,729

(22) Filed: Jun. 14, 2023

(30) Foreign Application Priority Data
Jun. 14, 2022 (FR) 22 05765

(51) Int. Cl. G06F 17/11; G06F 21/32

(52) U.S. Cl. CPC G06F 17/11; G06F 21/32

(57) ABSTRACT

A distributed-computing method for computing a metric f(X,Y) representative of a difference between a datum X comprising n bits (x₁, . . . , xₙ) and a datum Y, the metric f(X,Y) taking the form f(X,Y)=f_{X}(X)+Σᵢ₌₁ⁿfᵢ(xᵢ,Y)+f_{Y}(Y), the method being implemented by a system comprising m+1 devices and including for any j ranging from 1 to m, computing, by way of the device of index j, at least one intermediate datum depending on the datum X and on the datum Y, and transmitting to the device of index m+1 at least one result comprising or depending on each intermediate datum, and determining, by way of the device of index m+1, the metric f(X,Y), the determining comprising summing each result to obtain a value equal to Σᵢ₌₁ⁿfᵢ(xᵢ,Y) or a value equal to Σᵢ₌₁ⁿfᵢ(xᵢ,Y)+f_{Y}(Y).

### TECHNICAL FIELD

The present disclosure relates to a method for computing a metric representative of a difference between two data, the method being advantageously applicable in the field of biometrics.

### TECHNOLOGICAL BACKGROUND

Various metrics for determining whether two data are close or not are known. Hamming distance is one example thereof.

These metrics are especially used to compare an input biometric datum and a reference biometric datum enrolled and stored beforehand in a database.

Such databases and likewise any processing operations based on their content must be secured to retain confidentiality, this especially being the case for computation of a metric of the aforementioned type. Moreover, in certain countries, construction of such databases may be permitted only if this confidentiality is guaranteed.

### SUMMARY

One aim of the present disclosure is to make secure computation of a metric representative of a difference between two data.

To this end, according to a first aspect, a distributed-computing method for computing a metric f(X,Y) representative of a difference between a datum X comprising n bits (x₁, . . . , xₙ) and a datum Y is provided, the metric f(X,Y) taking the form:

f(X,Y)=f_{X}(X)+Σᵢ₌₁ⁿfᵢ(xᵢ,Y)+f_{Y}(Y)

where f_{X} is a function depending solely on the datum X, f_{Y} is a function depending solely on the datum Y, and for any i ranging from 1 to n, fᵢ is a predefined function, the method being implemented by a system comprising m+1 distinct devices (D₁, . . . , Dₘ₊₁) having respective indices ranging from 1 to m+1, with m≥2, the method comprising:
for any j ranging from 1 to m, computing at least one intermediate datum by means of the device of index j (Dⱼ), each intermediate datum depending on the datum X and on the datum Y, and transmitting to the device of index m+1 (Dₘ₊₁) at least one result comprising or depending on each intermediate datum,
determining, by means of the device of index m+1 (Dₘ₊₁), the metric f(X,Y), the determining comprising summing each result to obtain a value equal to Σᵢ₌₁ⁿfᵢ(xᵢ,Y) or a value equal to Σᵢ₌₁f(xᵢ,Y)+f_{Y}(Y).

The method according to the first aspect may also comprise the following optional features, which may be implemented on their own or in combination wherever technically possible.

In a first embodiment:
the datum X forms a vector of K data (X, . . . , X_{K}), where for any i ranging from 1 to K, the datum Xᵢ forms a vector of l bits (x_{K(i-1)+1}, . . . , x_{K(i-1)+l}),
the datum Y forms a vector (Y₁, . . . , Y_{K}), where for any i ranging from 1 to K, Yᵢ is an integer,
n=K.l, where K>1 and l>1,
for any i ranging from 1 to K and for any p ranging from 1 to l:

f_{K(i-1)+p}(x_{K(i-1)+p},Y)=c_{p,i}(Y)·x_{K(i-1)+p}

where c_{p,i}(Y) is a scalar the value of which may depend on i, on p and on the datum Y,
for any j ranging from 1 to m, the device of index j (Dⱼ) computes l intermediate data R_{j,1}(X), . . . , R_{j,l}(X), each intermediate datum being computed as follows: for any p ranging from 1 to l,

R_{j,p}(X)=Σᵢ₌₁ⁿDPF_{j,p}(a,c_{p,i}(Y);x_{K(i-1)+p})

where a is a predefined constant,
for any i ranging from 1 to K and for any p ranging from 1 to l, DPF_{1,p}(a,c_{p,i}(Y); ⋅), . . . , DPF_{m,p}(a,c_{p,i}(Y); ⋅) are m functions meeting the following conditions:

$${\sum }_{j = 1}^{m} D P {F}_{j , p} ( a , {c}_{p , i} ( Y ) ; x ) = \{ \begin{matrix}{c}_{p , i} ( Y ) & if x = a \\ 0 & if x \neq a\end{matrix}$$

In this first embodiment, the method may comprise the following steps:
for any j ranging from 1 to m, computing, by means of the device of index j (Dⱼ), a result Rⱼ(X) from the sum of the l intermediate data R_{j,1}(X), . . . , R_{j,l}(X),
for any j ranging from 1 to m, transmitting the result Rⱼ(X) to the device of index m+1 (Dₘ₊₁),
summing, by means of the device of index m+1 (Dₘ₊₁), the m results R₁(X), . . . , Rₘ(X) so as to obtain the value of the term Σᵢ₌₁ⁿfᵢ(xᵢ,Y).

Preferably, wherein for any j ranging from 1 to m, the result Rⱼ(X) is obtained by summing the l intermediate data R_{j,1}(X), . . . , R_{j,l}(X) and a term fⱼY stored by the device of index j (Dⱼ),

and wherein:

Σⱼ₌₁^{m}fⱼY=f_{Y}(Y)

In one variant of the first embodiment, allowing a metric consisting of a scalar product to be obtained:

a=1

f_{X}(X)=f_{Y}(Y)=0

and for any p ranging from 1 to l and for any i ranging from 1 to K:

c_{p,i}(Y)=2^{p-1}·Yᵢ

In another variant of the first embodiment, allowing a metric consisting of the square of a Euclidean distance to be obtained:

a=1

f_{X}(X)=Σᵢ₌₁^{K}Xᵢ²

f_{Y}(Y)=Σᵢ₌₁^{K}Yᵢ²

and wherein, for any p ranging from 1 to l and for any i ranging from 1 to K:

c_{p,i}(Y)=−2^{p}·Yᵢ

In another variant of the first embodiment, allowing a Mahalanobis distance to be obtained:

a=1

f_{X}(X)=X^{T}MX

f_{Y}(Y)=Y^{T}MY

where M is a predefined square matrix of the form (M_{u,v})_{u,v=1, . . . , K},
and wherein, for any p ranging from 1 to l and for any i ranging from 1 to K:

c_{p,i}(Y)=−2^{p}·Σᵥ₌₁^{K}M_{i,v}Yᵥ

In a second embodiment, allowing a metric consisting of a Hamming distance to be obtained:
the datum Y forms a vector of bits (y₁, . . . , yₙ),
the following is true:

f_{X}(X)=f_{Y}(Y)=0
for any i ranging from 1 to n:

fᵢ(xᵢ,Y)=xᵢ⊕yᵢ

where ⊕ is an exclusive disjunction,
for any j ranging from 1 to m, the device of index j (Dⱼ) computes an intermediate datum Rⱼ(X), as follows:

Rⱼ(X)=Σᵢ₌₁ⁿDPFⱼ(1−yᵢ,1;xᵢ)

in which DPF₁(0,1;⋅), . . . , DPFₘ(0,1;⋅) are m functions meeting the following conditions:

$${\sum }_{j = 1}^{m} D P {F}_{j} ( 0 , 1 ; x ) = \{ \begin{matrix}1 & if x = 0 \\ 0 & if x \neq 0\end{matrix}$$

in which DPF₁(1,1;⋅), . . . , DPFₘ(1,1;⋅) are m functions meeting the following conditions:

$${\sum }_{j = 1}^{m} D P {F}_{j} ( 1 , 1 ; x ) = \{ \begin{matrix}1 & if x = 1 \\ 0 & if x \neq 1\end{matrix}$$

and in which the device of index m+1 (Dₘ₊₁) obtains a value equal to Σᵢ₌₁ⁿfᵢ(xᵢ,Y) by summing the m results R₁(X), . . . , Rₘ(X).

Preferably, the datum X and the datum Y are biometric data.

According to a second aspect, a method is provided for carrying out biometric authentication or identification comprising steps of:
acquiring, by means of a sensor, a biometric datum X relating to an individual,
computing a metric f(X,Y) representative of a difference between the biometric datum X and a reference biometric datum Y by way of the method according to the first aspect,
comparing the metric f(X,Y) and a predefined threshold.

Preferably, the comparing step comprises carrying out distributed computations on the m+1 devices (D₁, . . . , Dₘ₊₁).

According to a third aspect, a computer-readable memory storing instructions that are executable by the computer in order to execute the steps of the method according to the first aspect or according to the second aspect is also provided.

According to a fourth aspect, a distributed-computing system (4) for computing a metric f(X,Y) representative of a difference between a datum X comprising n bits (x₁, . . . , xₙ) and a datum Y is also provided, wherein the metric f(X,Y) takes the form:

f(X,Y)=f_{X}(X)+Σᵢ₌₁ⁿfᵢ(xᵢ,Y)+f_{Y}(Y)

where f_{X} is a function depending on the datum X, f_{Y} is a function depending on the datum Y, and for any i ranging from 1 to n, fᵢ is a predefined function,
the system comprising m+1 distinct devices (D₁, . . . , Dₘ₊₁) having respective indices ranging from 1 to m+1, with m≥2, in which:
for any j ranging from 1 to m, the device of index j (Dⱼ) is configured to compute at least one intermediate datum, each intermediate datum depending on the datum X and on the datum Y, and to transmit to the device of index m+1 (Dₘ₊₁) at least one result comprising or depending on each intermediate datum,
the device of index m+1 (Dₘ₊₁) is configured to determine the metric f(X,Y), this determining comprising summing each result to obtain the value of the term Σᵢ₌₁ⁿfᵢ(xᵢ,Y) or the value of the term Σᵢ₌₁ⁿfᵢ(xᵢ,Y)+f_{Y}(Y).

According to a fifth aspect, a system is provided for carrying out biometric authentication or identification comprising:
a biometric sensor configured to acquire a biometric datum X relating to an individual,
a computing system (4) according to the fourth aspect for computing a metric f(X,Y) representative of a difference between the biometric datum X and a reference biometric datum Y,
comparing the metric f(X,Y) and a predefined threshold.

### DESCRIPTION OF THE FIGURES

Further features, aims and advantages will become apparent from the following description, which is purely illustrative and non-limiting and which should be read with reference to the appended drawings, in which:

FIG. 1 schematically illustrates a biometric authentication or identification system according to one embodiment.

FIG. 2 is a flowchart of steps of a biometric authentication or identification method according to one embodiment.

In all of the figures, elements that are similar have been designated by identical references.

### DETAILED DESCRIPTION OF THE INVENTION

1) Biometric Authentication or Identification System

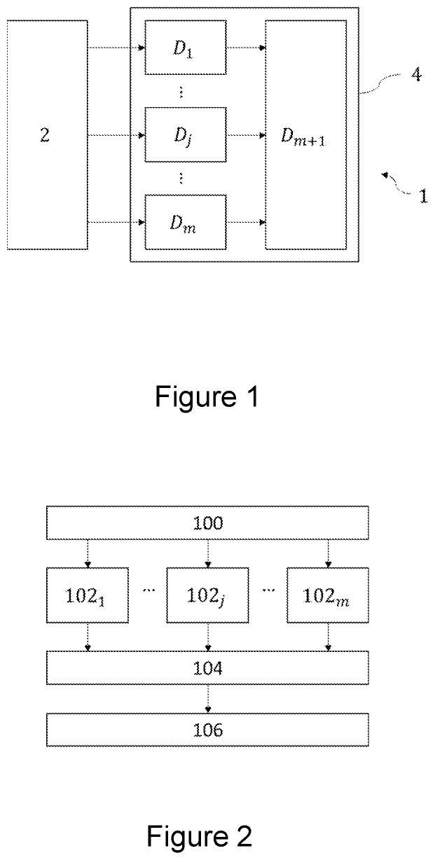

With reference to FIG. 1, a biometric authentication or identification system 1 comprises a biometric sensor 2 and a computing system 4.

The biometric sensor 2 is configured to acquire a biometric datum X relating to an individual. The biometric datum X may be obtained from a finger print or from an iris print or from a face for example. The biometric datum X comprises n bits (x₁, . . . ,xₙ).

The function of the computing system 4 is to carry out processing operations, and especially to compute a metric f(X,Y) representative of a difference between the biometric datum X acquired by the biometric sensor and a biometric datum Y. The biometric datum Y is a reference datum enrolled beforehand (for example by way of the biometric sensor 2 or indeed of another biometric sensor).

The computing system 4 comprises m+1 distinct devices D₁, . . . ,Dₘ₊₁ having respective indices ranging from 1 to m+1, with m≥2. It is in particular possible to choose m=2. The devices D₁, . . . , Dₘ₊₁ are remote from one another, and interconnected by a network of any type, whether wired or not.

The m devices D₁, . . . ,Dₘ are intended to carry out computations in parallel, these computations forming various contributions to the computation of the metric f(X,Y).

For any j ranging from 1 to m, the device Dⱼ comprises an input interface for receiving the biometric datum X, and for moreover receiving the biometric datum Y or indeed precomputed data that depend on the biometric datum Y.

In one variant, the biometric datum Y is stored in a local or remote database to which the device Dⱼ has access.

In another advantageous variant, precomputed data that depend on the biometric datum Y are stored by the device Dⱼ and the biometric datum Y is not stored as such either in the computing system 4 or in a local or remote database. Furthermore, each device Dj stores only one portion of the precomputed data depending on the biometric datum Y. This variant is advantageous because it improves the confidentiality of the biometric datum Y. In certain embodiments that will be described in detail below, the precomputed data comprise functions of the form DPF_{1,p}(a,c_{p,i}(Y);⋅).

For any j ranging from 1 to m, the device Dⱼ comprises at least one processor configured to apply processing that forms one contribution to the computation of the metric f(X,Y). The or each processor is of any type, for example a programmable circuit (ASIC, FPGA) or a circuit that is not programmable. The device Dⱼ further comprises a memory that stores a program comprising code instructions for applying this processing, when the program is executed by the or each processor of the device Dⱼ.

For any j ranging from 1 to m, the device Dⱼ comprises an output interface for transmitting data to the device Dₘ₊₁.

The device Dₘ₊₁ comprises an input interface for receiving data emanating from the m devices D₁, . . . , Dₘ₊₁.

The device Dₘ₊₁ moreover comprises at least one processor configured to apply processing especially comprising a final contribution to the computation of the metric f(X,Y). The or each processor is of any type, for example a programmable circuit (ASIC, FPGA) or a circuit that is not programmable. The device Dₘ₊₁ further comprises a memory that stores a program comprising code instructions for applying this processing, when the program is executed by the or each processor of the device Dₘ₊₁.

2) General Considerations Regarding the Metric f(X,Y)

The computing system 4 is in particular configured to compute a metric f(X,Y) of the following form:

f(X,Y)=f_{X}(X)+Σᵢ₌₁ⁿfᵢ(xᵢ,Y)+f_{Y}(Y)

where f_{X} is a function depending on the datum X, f_{Y} is a function depending on the datum Y, and for any i ranging from 1 to n, fᵢ is a predefined function.

The metric f(X,Y) may in particular be one of the following metrics:
The scalar product of the biometric data X and Y,
The square of the Euclidean distance between the biometric data X and Y,
The square of the Mahalanobis distance between the biometric data X and Y,
The Hamming distance between the biometric data X and Y.

These various embodiments are described in detail below.

### 3) Biometric Authentication or Identification Method

With reference to FIG. 2, a biometric authentication or identification method implemented by the system 1 comprises the following steps.

In an acquiring step 100, the biometric sensor 2 acquires the biometric datum X. The biometric datum X is transmitted by the biometric sensor 2 to the devices D₁, . . . , Dₘ.

For any j ranging from 1 to m, the device Dⱼ implements a processing operation designated by the reference 102ⱼ. The processing operation 102ⱼ comprises computing at least one intermediate datum, each intermediate datum depending on the datum X and on the datum Y, and transmitting to the device Dₘ₊₁ at least one result comprising or depending on each intermediate datum.

In a step 104, the device Dₘ₊₁ determines the metric f(X,Y) and to do so makes use of each result produced in the preceding steps. The procedure used to determine the metric in particular comprises summing each result delivered by the devices D₁, . . . , Dₘ to obtain a value equal to Σᵢ₌₁ⁿfᵢ(xᵢ,Y) or a value equal to Σᵢ₌₁ⁿfᵢ(xᵢ,Y)+f_{Y}(Y). The summation carried out and value obtained by the device Dₘ₊₁ depend on the type of metric computed, as will be seen below.

In a step 106, the device Dₘ₊₁ compares the computed metric f(X,Y) with a threshold. On the basis of this comparison, the device Dₘ₊₁ generates an authentication or identification result.

If the metric f(X,Y) is lower than the threshold, then the difference between the biometric data X and Y is considered to be small. In other words, the biometric datum X is considered to correspond to the biometric datum Y enrolled beforehand. In this case, the authentication or identification result generated by the system 1 is positive. The individual to whom the biometric datum X relates is then authenticated or identified.

If in contrast the metric f(X,Y) is not lower than the threshold, then the difference between the biometric data X and Y is considered to be large. In other words, the biometric datum X is considered not to correspond to the biometric datum Y enrolled beforehand. In this case, the authentication or identification result is negative. The individual to whom the biometric datum X relates is then not authenticated or identified.

The biometric authentication or identification method may be used in various applications. One thereof is control of access to a secure zone, for example a zone of embarkation into a means of transport such as an aeroplane.

### 3.1) Scalar Product

In a first embodiment, the metric f(X,Y) is the scalar product of the biometric data X and Y.

The input data of the computation of the metric f(X,Y) are then of the following form:
n=K.l, where K>1 and l>1.
The datum X forms a vector of K data (X₁, . . . , X_{K}), where for any i ranging from l to K, the datum Xᵢ forms a vector of l bits (x_{K(i-1)+1}, . . . , x_{K(i-1)+l}).
The datum Y forms a vector (Y₁, . . . , Y_{K}), where for any i ranging from 1 to K, Yᵢ is an integer.

Moreover, for any i ranging from 1 to K and for any p ranging from 1 to l:

f_{K(i-1)+p}(x_{K(i-1)+p},Y)=c_{p,i}(Y)·x_{K(i-1)+p}

where c_{p,i}(Y) is a scalar the value of which may depend on i, on p and on the datum Y.

More precisely, in the first embodiment, for any p ranging from 1 to l and for any i ranging from 1 to K:

c_{p,i}(Y)=2^{p-1}·Yᵢ

f_{X}(X)=f_{Y}(Y)=0

Moreover, the processing operations implemented by the computing system 4 are then the following.

The terms c_{p,i}(Y) may be computed in a preliminary step, before the acquiring step 100, or even for example during the enrollment of the biometric datum Y. Once computed, these terms c_{p,i}(Y) are stored in memory by the devices D₁ to Dₘ. Thus, when the biometric datum X is subsequently received by the computing system 4, the terms c_{p,i}(Y) are available.

Moreover, for any j ranging from 1 to m, the device Dⱼ computes l intermediate data R_{j,1}(X), . . . , R_{j,l}(X) in step 102ⱼ, each intermediate datum being computed as follows. For any p ranging from 1 to l,

R_{j,p}(X)=Σᵢ₌₁^{K}DPF_{j,p}(a,c_{p,i}(Y);x_{K(i-1)+p})

where a is a predefined constant equal to 1, and where, for any i ranging from 1 to K and for any p ranging from 1 to l, DPF_{1,p}(a,c_{p,i}(Y);⋅), . . . , DPF_{m,p}(a,c_{p,i}(Y);⋅) are m functions meeting the following conditions:

Σⱼ₌₁^{m}DPF_{j,p}(a,c_{p,i}(Y);x)=c_{p,i}(Y) if x=a

Σⱼ₌₁^{m}=DPF_{j,p}(a,c_{p,i}(Y);x)=0 if x≠a.

Thus, the m functions DPF_{1,p}(a,c_{p,i}(Y);⋅), . . . , DPF_{m,p}(a,c_{p,i}(Y);⋅) form a distributed point function on the m devices D₁ to Dₘ, respectively.

As indicated above, these m functions (depending on the terms c_{p,i}(Y) and on a) are preferably computed in advance and stored in the respective memories of the m devices D₁ to Dₘ, and the biometric datum Y is for its part not stored as such either in the computing system 4 or in a local or remote database.

Next, for any j ranging from 1 to m, the device Dⱼ computes, in step 102ⱼ, a result Rⱼ(X) from the sum of the l intermediate data R_{j,1}(X), . . . , R_{j,l}(X). More precisely, in the first embodiment, the result Rⱼ(X) is the sum of these l data, i.e.:

Rⱼ(X)=Σₚ₌₁^{l}R_{j,p}(X)

Next, for any j ranging from 1 to m, the device Dⱼ transmits the result Rⱼ(X) to the device Dₘ₊₁ of index m+1.

Thus, in the first embodiment, the device Dₘ₊₁ receives m results R₁(X), . . . , Rₘ(X) delivered by the devices D₁, . . . , Dₘ, respectively.

To obtain the value Σᵢ₌₁ⁿfᵢ(xᵢ,Y) (and therefore the scalar product f(X,Y) then f_{X}(X)=f_{Y}(Y)=0), the device Dₘ₊₁ computes the sum of these m results, as follows:

Σⱼ₌₁^{m}Rⱼ(X)=Σᵢ₌₁ⁿfᵢ(xᵢ,Y)=f(X,Y)

### 3.2) Square of the Euclidean Distance

In a second embodiment, the metric f(X,Y) is the square of the Euclidean distance between the biometric data X and Y.

The input data take the same form as in the first embodiment, and again, for any i ranging from 1 to K and for any p ranging from 1 to l:

f_{K(i-1)+p}(x_{K(i-1)+p},Y)=c_{p,i}(Y)·x_{K(i-1)+p}

where c_{p,i}(Y) is a scalar the value of which may depend on i, on p and on the datum Y.

However, unlike the first embodiment, for any p ranging from 1 to l and for any i ranging from 1 to K:

c_{p,i}(Y)=−2^{p}·Yᵢ

Moreover:

f_{X}(X)=Σᵢ₌₁^{K}Xᵢ²

f_{Y}(Y)=Σᵢ₌₁^{K}Yᵢ²

It is therefore necessary, in the second embodiment, to compute the terms f_{X}(X) and f_{Y}(Y), which are in principle not zero in contrast to the first embodiment.

The term f_{X}(X) may be computed by one of the m+1 devices of the computing system 4 from the biometric datum X, for example by the device Dₘ₊₁ or indeed by one of the other devices of the system.

In one advantageous variant, the term f_{X}(X) is computed by a device that is associated with the biometric sensor 2 (and that does not necessarily form part of the computing system 4) then is transmitted to the device Dₘ₊₁ or to one of the other devices of the system, which will then possibly include it in its result, which will subsequently be transmitted to the device Dₘ₊₁.

In one simple variant, the term f_{Y}(Y) is stored in memory by the device Dₘ₊₁ in advance. The term f_{Y}(Y) may then be computed in advance, before the acquiring step 100, by any one of the devices of the computing system 4. In this simple variant, the m results Rⱼ(X) are computed as in the first embodiment, and all that device Dₘ₊₁ need do is to sum the m results Rⱼ(X) with the terms f_{X}(X) and f_{Y}(Y) to obtain the metric f(X,Y) consisting of the square of the Euclidean distance between the biometric data X and Y.

In another variant, which is more secure and therefore advantageous, the computation of the f_{Y}(Y) is distributed over the m devices D₁ to Dₘ. From the biometric datum Y, m terms f₁Y, . . . , fₘY are computed in advance, these terms meeting the following condition:

Σⱼ₌₁^{m}fⱼY=f_{Y}(Y)

For any j ranging from 1 to m, the device Dⱼ stores in its memory the term fⱼY.

In this other variant, for any j ranging from 1 to m, the device Dⱼ computes the result Rⱼ(X) as follows:

Rⱼ(X)=Σₚ₌₁^{l}R_{j,p}(X)+fⱼY

Thus, each result Rⱼ(X) already includes a “segment” of the term f_{Y}(Y) and hence, subsequently, the device Dₘ₊₁ is able to obtain a value equal to Σᵢ₌₁^{m}Rⱼ(X)+f_{Y}(Y) by summing the m results delivered by the devices D₁ to Dₘ, respectively. In other words:

Σⱼ₌₁^{m}Rⱼ(X)=Σᵢ₌₁ⁿfᵢ(xᵢ,Y)+f_{Y}(Y)

This other variant is more secure, and therefore advantageous, because it allows the metric f(X,Y) to be computed without explicitly computing the term f_{Y}(Y). The value of the term f_{Y}(Y) cannot therefore be found in the memory of any one of the devices of the computing system 4.

### 3.3) Square of the Mahalanobis Distance

In a third embodiment, the metric f(X,Y) is the square of the Mahalanobis distance between the biometric data X and Y.

The input data take the same form as in the first embodiment and second embodiment, and again, for any i ranging from 1 to K and for any p ranging from 1 to l:

f_{K(i-1)+p}(x_{K(i-1)+p},Y)=c_{p,i}(Y)·x_{K(i-1)+p}

where c_{p,i}(Y) is a scalar the value of which depends on i, on p and on the datum Y, just as in the second embodiment.

However, unlike in the second embodiment:

f_{X}(X)=X^{T}MX

f_{Y}(Y)=Y^{T}MY

where M is a predefined square matrix of the form (M_{u,v})_{u,v=1, . . . , K}.

Moreover, for any p ranging from 1 to l and for any i ranging from 1 to K:

c_{p,i}(Y)=−2^{p}·Σᵥ₌₁^{K}M_{i,v}Yᵥ.

It may therefore be seen that the coefficients c_{p,i}(Y) are also dependent on the predefined matrix M.

Apart from these differences, the steps implemented in the second embodiment are also implemented in the third embodiment. It will in particular be noted that the two variants handling the term f_{Y}(Y) differently are applicable to the third embodiment.

### 3.4) Hamming Distance

In a fourth embodiment, the metric f(X,Y) is the Hamming distance between the biometric data X and Y.

In the fourth embodiment, the datum Y is simply processed as a vector of bits (y₁, . . . , yₙ).

Moreover:

f_{X}(X)=f_{Y}(Y)=0

fᵢ(xᵢ,Y)=xᵢ⊕yᵢ

where ⊕ is an exclusive disjunction.

In the fourth embodiment, for any j ranging from 1 to m, the device Dⱼ computes an intermediate datum Rⱼ(X) as follows in step 102ⱼ:

Rⱼ(X)=Σᵢ₌₁ⁿDPFⱼ(1−yᵢ,1;xᵢ)

in which DPF₁(0,1;⋅), . . . , DPFₘ(0,1;⋅) are m functions meeting the following conditions:

Σⱼ₌₁^{m}DPFⱼ(0,1;x)=1 if x=0

Σⱼ₌₁^{m}DPFⱼ(0,1;x)=0 if x≠0

and in which DPF₁(1,1;⋅), . . . , DPFₘ(1,1;⋅) are m functions meeting the following conditions:

Σⱼ₌₁^{m}DPFⱼ(1,1;x)=1 if x=1

Σⱼ₌₁^{m}DPFⱼ(1,1;x)=0 if x≠1

The m functions DPF₁(0,1;⋅), . . . , DPFₘ(0,1;⋅) form one distributed point function on the m devices D₁ to Dₘ, respectively. The m functions DPF₁(1,1;⋅), . . . , DPFₘ(1,1;⋅) form another distributed point function on the m devices D₁ to Dₘ, respectively.

Thus, in this fourth embodiment, for any j ranging from 1 to m, the device Dⱼ computes only one intermediate datum, forming a single result Rⱼ(X).

The device Dₘ₊₁ obtains a value equal to Σᵢ₌₁ⁿfᵢ(xᵢ,Y) by summing the m results R₁(X), . . . , Rₘ(X).

### 4) Other Variants of Embodiment

Above, embodiments in which the comparison between the metric f(X,Y) and the threshold is a step 106 implemented by the device Dₘ₊₁ were described. As a variant, it is possible for this comparison to be made in a distributed manner, i.e. to delegate to the devices D₁ to Dₘ additional computations producing contributions to this comparison. Such a distribution is known to those skilled in the art, and has been described in the document “Function Secret Sharing: Improvements and Extensions”, by Elette Boyle et al., CCS 2016. Said contributions may be added to the intermediate data discussed above, so as to be included in the results that are subsequently transmitted to the device Dₘ₊₁.

Moreover, embodiments have been described in which intermediate data are summed by the devices D₁ to Dₘ so as to produce results that are then transmitted to the device Dₘ₊₁. As a variant, it is conceivable for the devices D₁ to Dₘ to separately transmit the intermediate data to the device Dₘ₊₁, and for the task of summing said data to be delegated to the device Dₘ₊₁.

1. A distributed-computing method for computing a metric f(X,Y) representative of a difference between a datum X having n bits (x₁, . . . , xₙ) and a datum Y, the metric f(X,Y) taking the form:
f(X,Y)=f_{X}(X)+Σᵢ₌₁ⁿfᵢ(xᵢ,Y)+f_{Y}(Y)
where f_{X} is a function depending solely on the datum X, f_{Y} is a function depending solely on the datum Y, and for any i ranging from 1 to n, fᵢ is a predefined function,
the method being implemented by a system including m+1 distinct devices (D₁, . . . , Dₘ₊₁) having respective indices ranging from 1 to m+1, with m≥2, the method comprising:
for any j ranging from 1 to m, computing at least one intermediate datum by way of the device of index j (Dⱼ), each intermediate datum depending on the datum X and on the datum Y, and transmitting to the device of index m+1 (Dₘ₊₁) at least one result including or depending on each intermediate datum; and
determining, by way of the device of index m+1 (Dₘ₊₁), the metric f(X,Y), the determining including summing each result to obtain a value equal to Σᵢ₌₁ⁿfᵢ(xᵢ,Y) or a value equal to Σᵢ₌₁ⁿfᵢ(xᵢ,Y)+f_{Y}(Y).

2. The distributed-computing method according to claim 1, wherein:
the datum X forms a vector of K data (X₁, . . . , X_{K}), where for any i ranging from 1 to K, datum Xᵢ forms a vector of l bits (x_{K(i-1)+1}, . . . , x_{K(i-1)+l}),
the datum Y forms a vector (Y₁, . . . , Y_{K}), where for any i ranging from 1 to K, Yᵢ is an integer,
n=K.l, where K>1 and l>1,
for any i ranging from 1 to K and for any p ranging from 1 to l:
f_{K(i-1)+p}(x_{K(i-1)+p},Y)=c_{p,i}(Y)·x_{K(i-1)+p}
where c_{p,i}(Y) is a scalar a value of which may depend on i, on p and on the datum Y,
for any j ranging from 1 to m, the device of index j (Dⱼ) computes l intermediate data R_{j,1}(X), . . . , R_{j,l}(X), each intermediate datum being computed as follows: for any p ranging from 1 to l,
R_{j,p}(X)=Σᵢ₌₁^{K}DPF_{j,p}(a,c_{p,i}(Y);x_{K(i-1)+p})
where a is a predefined constant, and
for any i ranging from 1 to K and for any p ranging from 1 to l, DPF_{1,p}(a,c_{p,i}(Y);⋅) , . . . , DPF_{m,p}(a,c_{p,i}(Y);⋅) are m functions meeting the following conditions:
Σⱼ₌₁^{m}DPF_{j,p}(a,c_{p,i}(Y);x)=c_{p,i}(Y) if x=a
Σⱼ₌₁^{m}DPF_{j,p}(a,c_{p,i}(Y);x)=0 if x≠a.

3. The distributed-computing method according to claim 2, further comprising:
for any j ranging from 1 to m, computing, by way of the device of index j (Dⱼ), a result Rⱼ(X) from sum of the l intermediate data R_{j,1}(X), . . . , R_{j,l}(X);
for any j ranging from 1 to m, transmitting the result Rⱼ(X) to the device of index m+1 (Dₘ₊₁); and
summing, by way of the device of index m+1 (Dₘ₊₁), the m results R₁(X), . . . , Rₘ(X) to obtain a value of term Σᵢ₌₁ⁿfᵢ(xᵢ,Y).

4. The distributed-computing method according to claim 2, wherein for any j ranging from 1 to m, the result Rⱼ(X) is obtained by summing the l intermediate data R_{j,1}(X), . . . , R_{j,l}(X) and a term fⱼY stored by the device of index j (Dⱼ),
and wherein:
Σⱼ₌₁^{m}fⱼY=f_{Y}(Y).

5. The distributed-computing method according to claim 2, wherein:
a=1
f_{X}(X)=f_{Y}(Y)=0
and for any p ranging from 1 to l and for any i ranging from 1 to K:
c_{p,i}(Y)=2^{p-1}·Yᵢ.

6. The distributed-computing method according to claim 2, wherein:
a=1
f_{X}(X)=Σᵢ₌₁^{K}Xᵢ²
f_{Y}(Y)=Σᵢ₌₁^{K}Yᵢ²
and wherein, for any p ranging from 1 to l and for any i ranging from 1 to K:
c_{p,i}(Y)=−2^{p}·Yᵢ.

7. The distributed-computing method according to claim 2, wherein:
a=1
f_{X}(X)=X^{T}MX
f_{Y}(Y)=Y^{T}MY
where M is a predefined square matrix of form (M_{u,v})_{u,v=1, . . . , K},
and wherein, for any p ranging from 1 to l and for any i ranging from 1 to K:
c_{p,i}(Y)=−2^{p}·Σᵥ₌₁^{K}M_{i,v}Yᵥ.

8. The distributed-computing method according to claim 1, wherein:
the datum Y forms a vector of bits (y₁, . . . , yₙ),
the following is true:
f_{X}(X)=f_{Y}(Y)=0
for any i ranging from 1 to n:
fᵢ(xᵢ,Y)=xᵢ⊕yᵢ
where ⊕ is an exclusive disjunction,
for any j ranging from 1 to m, the device of index j (Dⱼ) computes an intermediate datum Rⱼ(X), as follows:
Rⱼ(X)=Σᵢ₌₁ⁿDPFⱼ(1−yᵢ,1;xᵢ)
in which DPF₁(0,1;⋅), . . . , DPFₘ(0,1;⋅) are m functions meeting the following conditions:
Σⱼ₌₁^{m}DPFⱼ(0,1;x)=1 if x=0
Σⱼ₌₁^{m}DPFⱼ(0,1;x)=0 if x≠0
in which DPF₁(1,1;⋅), . . . , DPFₘ(1,1;⋅) are m functions meeting the following conditions:
Σⱼ₌₁^{m}DPFⱼ(1,1;x)=1 if x=1
Σⱼ₌ₘDPFⱼ(1,1;x)=0 if x≠1
and in which the device of index m+1 (Dₘ₊₁) obtains a value equal to Σᵢ₌₁ⁿfᵢ(xᵢ,Y) by summing the m results R₁(X), . . . , Rₘ(X).

9. The distributed-computing method according to claim 1, wherein the datum X and the datum Y are biometric data.

10. A method for carrying out biometric authentication or identification comprising:
acquiring, by way of a sensor, a biometric datum X relating to an individual;
computing a metric f(X,Y) representative of a difference between the biometric datum X and a reference biometric datum Y by way of the method according to claim 1; and
comparing the metric f(X,Y) and a predefined threshold.

11. The method according to claim 10, wherein the comparing further comprises carrying out distributed computations on the m+1 devices (D₁, . . . , Dₘ₊₁).

12. A non-transitory computer-readable memory storing instructions that are executable by a computer in order to execute the method according to claim 1.

13. A distributed-computing system for computing a metric f(X,Y) representative of a difference between a datum X comprising n bits (x₁, . . . , xₙ) and a datum Y, wherein the metric f(X,Y) takes the form:
f(X,Y)=f_{X}(X)+Σᵢ₌₁ⁿfᵢ(xᵢ,Y)+f_{Y}(Y)
where f_{X} is a function depending on the datum X, f_{Y} is a function depending on the datum Y, and for any i ranging from 1 to n, fᵢ is a predefined function, the system comprising:
m+1 distinct devices (D₁, . . . , Dₘ₊₁) having respective indices ranging from 1 to m+1, with m≥2, wherein
for any j ranging from 1 to m, a device of index j (Dⱼ) is configured to compute at least one intermediate datum, each intermediate datum depending on the datum X and on the datum Y, and to transmit to the device of index m+1 (Dₘ₊₁) at least one result comprising or depending on each intermediate datum, and
a device of index m+1 (Dₘ₊₁) is configured to determine the metric f(X,Y), this determining including summing each result to obtain the value of the term Σᵢ₌₁ⁿfᵢ(xᵢ,Y) or the value of the term Σᵢ₌₁ⁿfᵢ(xᵢ,Y)+f_{Y}(Y).

14. A system for carrying out biometric authentication or identification comprising:
a biometric sensor configured to acquire a biometric datum X relating to an individual;
the distributed-computing computing system according to claim 13, wherein
a metric f(X,Y) representative of a difference between the biometric datum X and a reference biometric datum Y is computed, and
the metric f(X,Y) and a predefined threshold are compared.

15. The distributed-computing method according to claim 3, wherein for any j ranging from 1 to m, the result Rⱼ(X) is obtained by summing the l intermediate data R_{j,1}(X), . . . , R_{j,l}(X) and a term fⱼY stored by the device of index j (Dⱼ), and wherein:
Σⱼ₌₁^{m}fⱼY=f_{Y}(Y).

16. The distributed-computing method according to claim 3, wherein:
a=1
f_{X}(X)=f_{Y}(Y)=0
and for any p ranging from 1 to l and for any i ranging from 1 to K:
c_{p,i}(Y)=2^{p-1}·Yᵢ.

17. The distributed-computing method according to claim 4, wherein:
a=1
f_{X}(X)=f_{Y}(Y)=0
and for any p ranging from 1 to l and for any i ranging from 1 to K:
c_{p,i}(Y)=2^{p-1}·Yᵢ.

18. The distributed-computing method according to claim 3, wherein:
a=1
f_{X}(X)=Σᵢ₌₁^{K}Xᵢ²
f_{Y}(Y)=Σᵢ₌₁^{K}Yᵢ²
and wherein, for any p ranging from 1 to l and for any i ranging from 1 to K:
c_{p,i}(Y)=−2^{p}·Yᵢ.

19. The distributed-computing method according to claim 4, wherein:
a=1
f_{X}(X)=Σᵢ₌₁^{K}Xᵢ²
f_{Y}(Y)=Σᵢ₌₁^{K}Yᵢ²
and wherein, for any p ranging from 1 to l and for any i ranging from 1 to K:
c_{p,i}(Y)=−2^{p}·Yᵢ.
